(19) United States
(12) Patent Application Publication
(10) Pub. No.: US 2026/0322250 A1
(43) Pub. Date: Oct. 15, 2026

(54) ACTIVE DISCHARGE SOLUTION FOR DC-LINK CAPACITOR THROUGH PARASITIC CAPACITORS OF TRACTION INVERTER'S SWITCHING DEVICES

(71) Applicant: Cummins Inc., Columbus, IN (US)

(72) Inventor: Hussain Khthear Sayed Subhi, Columbus, IN (US)

(21) Appl. No.: 19/641,876

(22) Filed: Apr. 8, 2026

Related U.S. Application Data
(60) Provisional application No. 63/788,963, filed on Apr. 15, 2025.

(51) Int. Cl. H02M 1/32; B60L 3/00; B60L 50/60; H02M 1/00; H02M 1/12; H02M 7/5387

(52) U.S. Cl. CPC H02M 1/322; B60L 3/003; B60L 50/60; H02M 1/0009; H02M 1/0054; H02M 1/12; H02M 7/53871; B60L 2210/42

(57) ABSTRACT

Methods and systems are provided for safely discharging a direct-current link capacitor that is operatively connected to an inverter in a battery circuit via pulse width modulation (PWM). A PWM sequence is performed after experiencing a critical event and while the direct-current link capacitor is above a safe voltage to inhibit residual energy mishaps resulting from the critical event. A number of switches in the PWM sequence correspond to a discharge time of the direct-current link capacitor to the safe voltage.

### CROSS REFERENCE TO RELATED APPLICATION

This application claims the benefit of U.S. Provisional Application No. 63/788,963, filed Apr. 15, 2025, which is herein incorporated by reference in its entirety for all purposes.

### BACKGROUND

Gate drivers are essential components in power electronics systems, playing a pivotal role in controlling and driving the switching behavior of power semiconductors, such as field-effect transistors (FETs) and insulated-gate bipolar transistors (IGBTs). These drivers act as intermediaries between the control circuitry, often a microcontroller or a digital signal processor (DSP), and the power devices, ensuring efficient and precise operation under a wide range of conditions. The core function of gate drivers is to provide the necessary voltage and current to rapidly charge and discharge the gate capacitance of the power device, enabling fast and efficient switching while minimizing losses.

Modern gate drivers are critical for high-performance applications like battery electric vehicles (BEVs), renewable energy systems, industrial motor drives, and data centers. In BEVs, for instance, gate drivers are central to operating inverters, DC-DC converters, and battery management systems (BMS). By enabling precise switching of power devices, they facilitate efficient power conversion and motor control, contributing to overall system performance and energy savings. The evolution of advanced gate driver technologies has also enabled compatibility with wide-bandgap semiconductors, such as silicon carbide (SiC) and gallium nitride (GaN) devices, which offer higher efficiency and thermal performance compared to traditional silicon-based devices.

Gate drivers integrate a range of features to enhance safety, reliability, and efficiency. For example, many modern drivers incorporate desaturation detection (DESAT) to identify and mitigate short-circuit faults within microseconds, thereby protecting the power devices from damage. Programmable dead-time control prevents simultaneous conduction of high-side and low-side switches in half-bridge configurations, reducing the risk of shoot-through faults. Additionally, features like active miller clamps and adaptive slew rate control address challenges related to parasitic effects and electromagnetic interference (EMI), ensuring stable operation under high dv/dt conditions and compliance with automotive electromagnetic compatibility (EMC) standards.

Diagnostics and monitoring capabilities are also integral to advanced gate drivers. These include real-time feedback on gate voltage, current, and temperature, enabling predictive maintenance and fault detection. Such features are crucial for applications requiring high reliability and functional safety compliance, such as automotive systems adhering to ISO 26262 standards. Gate drivers also support communication protocols like SPI, allowing seamless integration with control systems for configuration and real-time monitoring.

The ongoing innovation in gate driver technology focuses on enhancing efficiency, minimizing losses, and improving system reliability. For example, the adoption of SiC-based gate drivers has enabled higher switching frequencies, reducing the size and weight of power systems while maintaining thermal stability. These advancements are driving the development of next-generation power electronics systems, ensuring higher power density, improved energy efficiency, and enhanced safety across a range of applications.

### SUMMARY

Gate drivers serve as useful components in power electronics systems by controlling the switching behavior of power semiconductors, such as field-effect transistors (FETs) and insulated-gate bipolar transistors (IGBTs). These devices act as intermediaries between control circuits and power devices, ensuring efficient operation while minimizing losses. In applications such as battery electric vehicles (BEVs), renewable energy systems, and industrial motor drives, gate drivers facilitate precise switching, improving energy efficiency and system performance. Modern gate drivers incorporate features like desaturation detection for fault mitigation, programmable dead-time control to prevent shoot-through faults, and adaptive slew rate control to manage electromagnetic interference (EMI). Additionally, they provide real-time diagnostics, including voltage, current, and temperature monitoring, supporting predictive maintenance and functional safety compliance. Advancements in gate driver technology, particularly with silicon carbide (SIC) and gallium nitride (GaN) devices, enable higher switching frequencies and improved thermal performance, contributing to more compact and reliable power electronics solutions.

### Summary

The principles of the present disclosure can be applied across various vehicle configurations, optimizing power distribution, efficiency, and adaptability in multi-mode hybrid vehicle systems. The following Examples illustrate practical implementations of these principles in different drivetrain architectures:

In Example 1, a method for safely discharging a direct current (DC) link capacitor that is operatively connected to an inverter in a battery circuit via pulse width modulation (PWM), the method comprising: performing a PWM sequence after experiencing a critical event and while the DC-Link Capacitor is above a safe voltage to inhibit residual energy mishaps resulting from the critical event, a number of switches in the PWM sequence corresponding to a discharge time of the DC-Link Capacitor to the safe voltage.

In Example 2, the method as Example 1 describes, wherein the PWM sequence engages at least one of a top end field-effect transistor (FET) and a bottom end FET, each of which is operatively connected to the inverter such that the DC-Link Capacitor is discharged to a top end parasitic capacitance when the PWM sequence engages the top end FET and the DC-Link Capacitor is discharged to a bottom end parasitic capacitance when the PWM sequence engages the bottom end FET.

In Example 3, the method as either of Examples 1 or 2 describe, wherein the PWM sequence engages both the top end FET and the bottom end FET.

In Example 4, the method as any of Examples 1-3 describe, wherein the PWM sequence toggles between the top end FET and the bottom end FET.

In Example 5, the method as any of Examples 1~4 describe, wherein the discharge time is less than or equal to 5 seconds.

In Example 6, the method as any of Examples 1-5 describe, wherein the PWM sequence operates independently from monitoring at least one of a monitored voltage that is indicative of a voltage at the DC-Link Capacitor and a monitored current that is indicative of a current at the DC-Link Capacitor.

In Example 7, the method as any of Examples 1-6 describe, wherein the PWM sequence operates independently from monitoring both a monitored voltage that is indicative of a voltage at the DC-Link Capacitor and a monitored current that is indicative of a current at the DC-Link Capacitor.

In Example 8, the method as any of Examples 1-7 describe, wherein the discharge time is set so as to minimize risk of thermal runaway by inhibiting shoot through and to minimize stress on components in the battery circuit.

In Example 9, a device for safely discharging a DC-Link Capacitor that is operatively connected to an inverter in a battery circuit comprising: a storage device; and a processor executing program instructions stored in the storage device and being configured to perform a pulse width modulation sequence after experiencing a critical event and while the DC-Link Capacitor is above a safe voltage to inhibit residual energy mishaps resulting from the critical event, a number of switches in the pulse width modulation sequence corresponding to a discharge time of the DC-Link Capacitor to the safe voltage.

In Example 10, the device as Example 9 describes, wherein the PWM sequence engages at least one of a top end field-effect transistor (FET) and a bottom end FET, each of which is operatively connected to the inverter such that the DC-Link Capacitor is discharged to a top end parasitic capacitance when the PWM sequence engages the top end FET and the DC-Link Capacitor is discharged to a bottom end parasitic capacitance when the PWM sequence engages the bottom end FET.

In Example 11, the device as either of Examples 9 or 10 describe, wherein the PWM sequence engages both the top end FET and the bottom end FET.

In Example 12, the device as any of Examples 9-11 describe, wherein the PWM sequence toggles between the top end FET and the bottom end FET.

In Example 13, the device as any of Examples 9-12 describe, wherein the discharge time is less than or equal to 5 seconds.

In Example 14, the device as any of Examples 9-13 describe, wherein the PWM sequence operates independently from monitoring at least one of a monitored voltage that is indicative of a voltage at the DC-Link Capacitor and a monitored current that is indicative of a current at the DC-Link Capacitor.

In Example 15, the device as any of Examples 9-14 describe, wherein the PWM sequence operates independently from monitoring both a monitored voltage that is indicative of a voltage at the DC-Link Capacitor and a monitored current that is indicative of a current at the DC-Link Capacitor.

In Example 16, the device as any of Examples 9-15 describe, wherein the discharge time is set so as to minimize risk of thermal runaway by inhibiting shoot through and to minimize stress on components in the battery circuit.

In Example 17, a system for safely discharging a DC-Link Capacitor that is operatively connected to an inverter in a battery circuit comprising one or more processors configured to perform a pulse width modulation sequence after experiencing a critical event and while the DC-Link Capacitor is above a safe voltage to inhibit residual energy mishaps resulting from the critical event, a number of switches in the pulse width modulation sequence corresponding to a discharge time of the DC-Link Capacitor to the safe voltage.

In Example 18, the system as Example 17 describes, wherein the PWM sequence engages at least one of a top end field-effect transistor (FET) and a bottom end FET, each of which is operatively connected to the inverter such that the DC-Link Capacitor is discharged to a top end parasitic capacitance when the PWM sequence engages the top end FET and the DC-Link Capacitor is discharged to a bottom end parasitic capacitance when the PWM sequence engages the bottom end FET.

In Example 19, the system as either of Examples 17 or 18 describe, wherein the PWM sequence engages both the top end FET and the bottom end FET.

In Example 20, the system as any of Examples 17-19 describe, wherein the PWM sequence toggles between the top end FET and the bottom end FET.

The examples discussed in the subsequent sections should therefore be viewed as illustrative implementations, rather than limiting definitions of the disclosed technology. Any modifications, enhancements, or refinements made to suit specific applications would be understood by those skilled in the art to be logical extensions of the principles presented herein.

### BRIEF DESCRIPTION OF THE DRAWINGS

FIG. 1 is a schematic diagram of a dual-axle multi-mode adjustable hybrid vehicle system with integrated front axle according to embodiments disclosed herein.

FIG. 2 is a schematic diagram of an integrated axle according to embodiments disclosed herein.

FIG. 3 is a schematic diagram of another dual-axle multi-mode adjustable hybrid vehicle system with integrated front axle according to embodiments disclosed herein.

FIG. 4 is a schematic diagram of an example of a three-axle multi-mode adjustable hybrid vehicle system with integrated front axle according to embodiments disclosed herein.

FIG. 5 is a schematic diagram of an example of a three-axle multi-mode adjustable hybrid vehicle system with integrated front axle according to embodiments disclosed herein.

FIG. 6 is a schematic diagram of an example of a three-axle multi-mode adjustable hybrid vehicle system with integrated front axle according to embodiments disclosed herein.

FIG. 7 is a schematic diagram of a controller operatively coupled with other components of the system according to embodiments disclosed herein.

FIG. 8 is a time vs voltage graph illustrating the relationship between DC-Link voltage and the different zones of operation according to embodiments disclosed herein.

FIG. 9A is a schematic diagram illustrating a layout of a microcontroller and the individual high-side (HS) and low-side (LS) drivers according to embodiments disclosed herein

FIG. 9B is a schematic diagram providing an enlarged view detailing the interaction between field-effect transistors (FETs) and the DC-Link Capacitor according to embodiments disclosed herein.

FIG. 10A is a schematic diagram of an electric machine implementing the DC-Link capacitor and switching power modules according to embodiments disclosed herein.

FIG. 10B is a schematic diagram illustrating an inverter and a switching structure that facilitates capacitor discharge according to embodiments disclosed herein.

FIGS. 11A through 11C are schematic diagrams illustrating three discharge cycles of the switching assembly used to carry out the pulse width modulation discharge sequence according to embodiments disclosed herein.

FIG. 12 is a flowchart of a method according to principles of the present disclosure for safely discharging a DC-Link Capacitor using pulse width modulation according to embodiments disclosed herein.

### DETAILED DESCRIPTION

Active discharge of high-voltage (HV) direct-current (DC) input capacitors in battery electric vehicles (BEVs) employs various methodologies, each with unique advantages and challenges. One approach involves toggling safety input pins of specific driver families to charge or discharge power module parasitic capacitors. This method benefits from the availability of safety pins during microcontroller (MCU) or KL30 failures, with no associated risk of thermal runaway. However, its limitations include restricted availability of input safety pins per gate driver, limited switching frequency as the safety pins are not intended for high-frequency operation, and safety concerns regarding their use for active discharge functions.

Another methodology overlaps the pulse-width modulation (PWM) signals of top and bottom field-effect transistors (FETs) in a single inverter leg to create an intended shoot-through effect. While this method avoids the need for intervention with input safety pins, it presents a significant risk of thermal runaway. Additionally, challenges include monitoring fast FET current with sensing circuit speeds up to 2.7 nanoseconds, disabling overvoltage protection associated with the gate driver, and the potential degradation of FET reliability due to peak current stresses.

A third methodology operates one FET in the linear region while toggling the other in a single inverter leg. This approach provides better risk management of thermal runaway and allows for controlled current regulation through the FETs. Nevertheless, it shares similar challenges with the previous method, including difficulties in monitoring FET current at high speeds, the need to disable overvoltage protection, and the reliance on higher leg impedance to limit current during shoot-through conditions.

These methodologies highlight the trade-offs between safety, performance, and reliability in active discharge systems for BEVs. Addressing the identified challenges is crucial for developing innovative solutions that enhance system robustness and compliance with safety standards. To that end, this disclosure provides a solution that is based on toggling the top and bottom FETs through PWM signals. In examples, the PWM signals will be switching with several tens of kHz. Advantageously, examples of the principles disclosed herein require no voltage and/or current monitoring during the discharge process. Risk of thermal runaway is minimized as there is no shoot through, and stresses on devices from experienced voltages and current can be minimized. Implementations of these principles can be advanced via any gate driver through software/or hardware or similar.

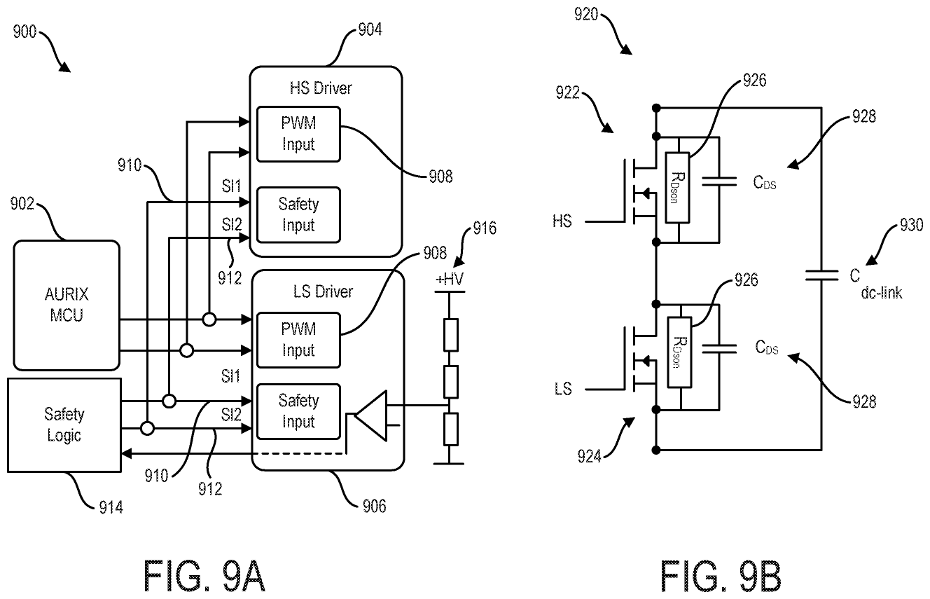

For example, FIG. 8 shows a time vs voltage graph 800 illustrating the relationship between DC-Link voltage and the different zones of operation. The disclosed system focuses on the safe and efficient active discharge of HV DC input capacitors in battery electric vehicles (BEVs) during critical events, such as vehicle crashes, to prevent short-circuit fires and electrical shocks from residual energy. Adhering to ISO-6469 safety standards, the system ensures the HV DC-link voltage in Class B electric circuits is reduced to or below 60V within five seconds after the vehicle halts or the initial crash occurs, as shown in FIG. 8. In a first zone 802, which begins when the battery is disconnected, the DC-Link Capacitor is discharged following the vehicle stop. The first zone 802 may last a period of time (tdischarge) in the order of milliseconds (e.g., no longer than 100 ms, no longer than 50 ms, no longer than 30 ms, no longer than 20 ms, no longer than 10 ms, no longer than 5 ms), where shorter the time, the better. Then, in a second zone 804, the inverter current is decreased (e.g., to zero electric current) in order to minimize the power resistor value, where the smaller the value, the better. In a third zone 806, once the electric circuits are reduced to or below 60V (a threshold value which may be changed according to use case or regulations) at tₘ seconds, the system would be operating in a safe area thereafter. It is to be noted that the time between the initial vehicle stop and the reaching of lower threshold voltage value (i.e., time at tₘ) is within a threshold time, such as five seconds (which may be changed according to use case or regulations).

This discharge process leverages dedicated power electronics circuits employing resistors, complemented by advanced gate driver technology. The methodology integrates features like desaturation detection, fault diagnostics, and redundant safety mechanisms. These innovations enable rapid, reliable discharge, ensuring compliance with safety regulations while improving the robustness and longevity of the system. By adopting these advanced designs, the solution provides a safer, more efficient, and compliant framework for managing high-voltage energy in BEVs.

Electrified vehicles are a type of transportation technology that utilizes electricity as its main source of power. This technology is becoming increasingly popular due to its environmental benefits and cost-effectiveness. Electrified vehicles include fully electric vehicles, hybrid electric vehicles, and fuel cell electric vehicles. Principles of the present disclosure are applicable in whole or in part to each of these vehicles.

Fully electric vehicles are powered solely by electricity and do not require any gasoline or diesel fuel. These vehicles use rechargeable batteries to store energy, which is then used to power the electric motor. Fully electric vehicles are environmentally friendly, producing zero emissions and requiring less maintenance than traditional gasoline-powered vehicles.

Hybrid electric vehicles combine an electric motor with a gasoline or diesel engine. These vehicles use the electric motor for low-speed driving and the gasoline or diesel engine for high-speed driving. Hybrid electric vehicles are more fuel-efficient than traditional gasoline-powered vehicles and produce lower emissions.

Fuel cell electric vehicles use hydrogen as their main source of energy. The hydrogen is converted into electricity through a fuel cell, which powers the electric motor. Fuel cell electric vehicles produce zero emissions and are highly efficient, making them an environmentally friendly option for transportation. However, the infrastructure for hydrogen fueling stations is still limited, making it difficult for fuel cell electric vehicles to become mainstream.

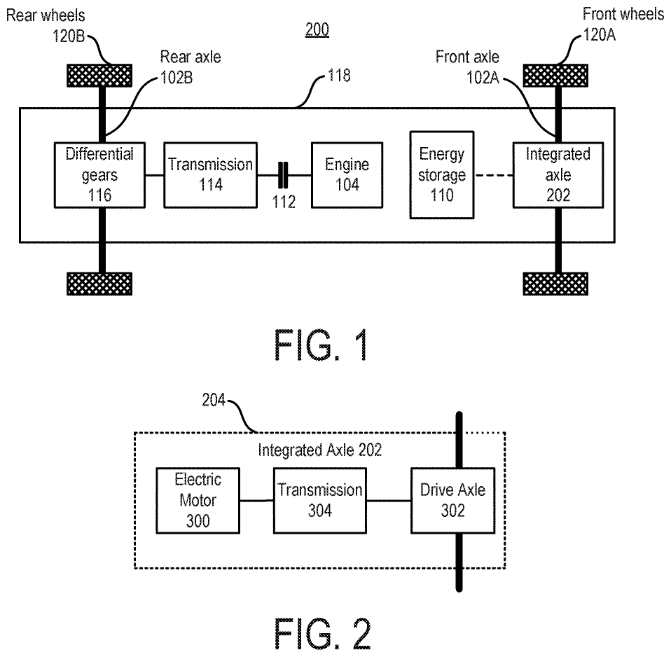

Now turning to the figures, FIG. 1 shows an example of a multi-mode hybrid vehicle system 200 as disclosed herein. The system 200 includes a plurality of motive power sources. For example, an integrated axle 202 is mechanically coupled with a steerable front axle 102A such that the integrated axle 202 is used as a motive power source to provide the motive force to drive the front wheels 120A using electrical energy provided form the energy storage 110. The rear axle 102B is mechanically coupled with the differential gears 116, which is mechanically coupled with the transmission 114, which is mechanically coupled with or decoupled from the engine 104 via the clutch 112. The rear axle 102B, therefore, is controlled using the motive force provided by the engine 104, another power motive source. For simplicity, the inverter(s) for the integrated axle 202 and the fuel reservoir 108 coupled with the engine 104 are not shown.

As disclosed herein, an “integrated axle” includes a type of electric axle drive that is affixed to the wheels to rotate them. In examples, the integrated axle combines the functionality of an electric motor-generator, power electronics such as an inverter, and in some examples a cooling circuit to reduce cost and increase efficiency in a single component. Integrated axles are neither directly nor indirectly coupled with any combustion engine, thereby using solely the motor-generator included therein to provide mechanical power to a drive axle coupled thereto.

In some examples, the motor-generator of the integrated axle may be mounted on the drive axle. In some embodiments, the integrated axle is configured to reduce interfaces and components that may induce efficiency loss. Examples of such components include wires and copper cables that link the components together, plugs, bearings for rotating components, and separate cooling circuits for the electric motor and power electronics. The integrated axles are also more compact than the electric motor, the power electronics, and the cooling circuits therefor being individually installed, thus saving installation space within the chassis frames of the vehicle and allowing more room therein. Each integrated axle is configured independently of other sat(s) in the system. In some examples, the integrated axle may also include a two-speed or three-speed gearbox.

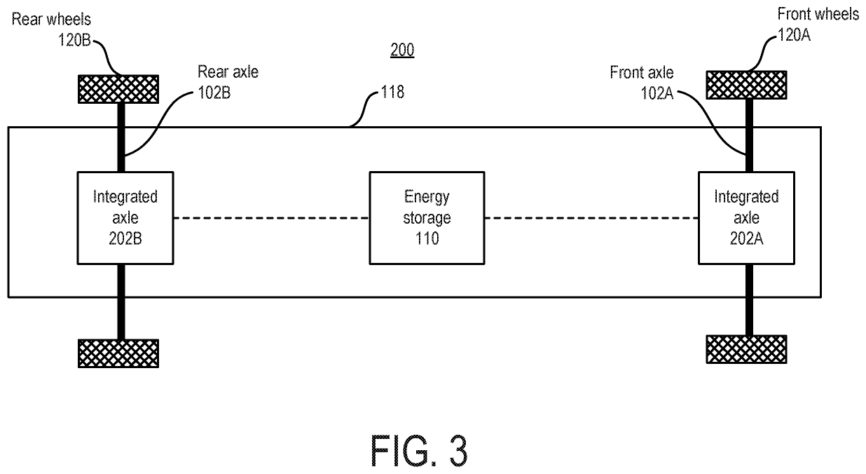

As shown in the embodiment of FIG. 1, the integrated axle 202 is mechanically coupled with a drive axle 102, such as the front axle 102A as shown in FIG. 1. The drive axle 102 is mechanically coupled with a pair of wheels 120, such as the pair of front wheels 120A as shown in FIG. 1. Although not shown, a controller is electrically coupled with the integrated axle 202. Based on the inputs received, the controller turns on (activates or engages) or turns off (deactivates or disengages) one or more of these components to achieve the different modes shown herein. FIG. 2 shows some of the components of the integrated axle 202. For example, the integrated axle 202 includes an electric motor-generator 300, a drive axle 302, and a transmission 304. Other components such as the aforementioned inverter and/or cooling circuit may be included in the integrated axle 202, as suitable. These components are separately or independently operable from the other components (e.g., the transmission 304 is separately operable from the transmission 114). The components of the integrated axle 202 (e.g., the electric motor-generator and at least a portion of the drive axle, etc.) may be mechanically mated to, coupled to, affixed to, or implemented within a common housing 204. The housing may be any suitable structure which supports the positioning of the components, as well as to provide protection of the components.

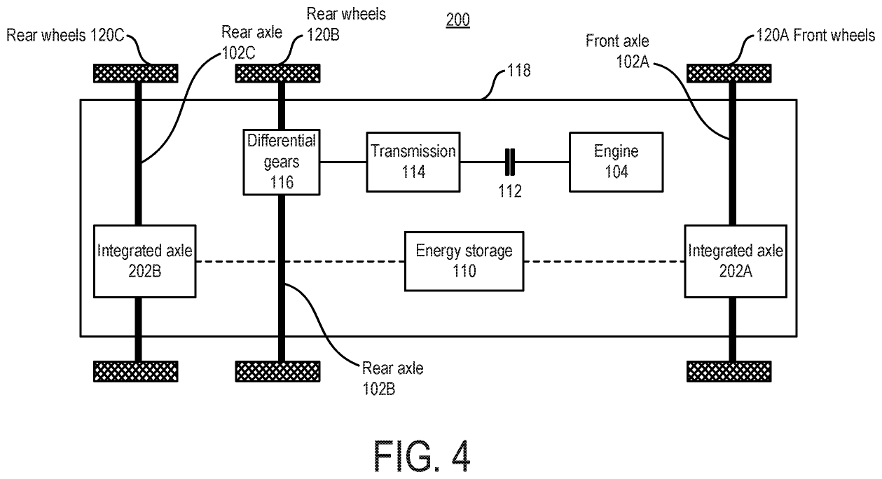

FIG. 3 shows an example of the system 200 which incorporates two integrated axles 202A and 202B, with one implemented for each of the front axle 102A and the rear axle 102B, respectively. The integrated axles 202A and 202B are operated using the controller (not shown) and the electrical energy for these axles are provided by a common energy storage 110, such as a battery or a battery pack. The two integrated axles 202A and 202B may be separately and independently operated so as to be implementable as two separate and distinct motive power sources. Each integrated axle may include the same components, including for example an electric motor and a transmission as explained herein, that are separately operable from each other, although they may be operable together simultaneously as well, as suitably controlled by the controller.

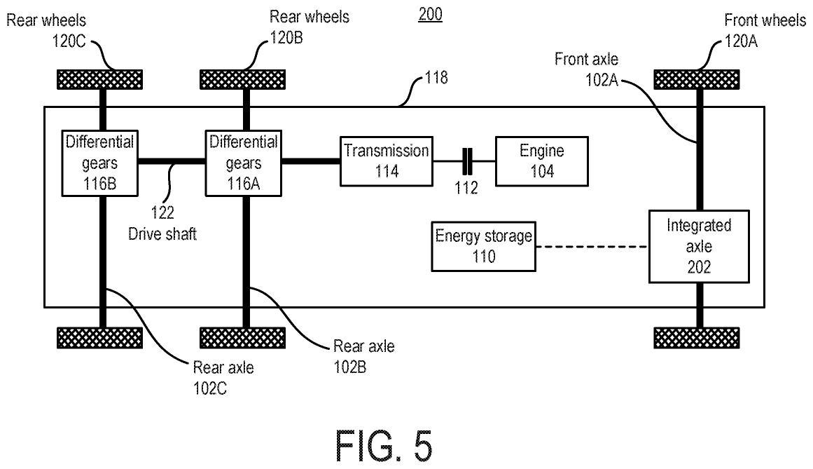

FIGS. 4 through 6 show examples of the system 200 where more than two axles (and in effect, more than four wheels) are implemented, with different combinations of integrated electrical axles and engine-powered axles implemented therein. It is to be understood that these figures are provided for illustrative purposes only, such that any additional number of axles may be implemented according to the need of the vehicle and its operation.

FIG. 4 shows an example of the system 200 which incorporates three axles 102A, 102B, and 102C, of which two of them, the front axle 102A and the rear axle 102C, have integrated axles 202A and 202B, respectively, coupled therewith. The other axle (rear axle) 102B is coupled with the engine 104 via the clutch 112, transmission 114, and differential gears 116 as shown. The integrated axles 202A and 202B are electrically powered by the energy storage 110.

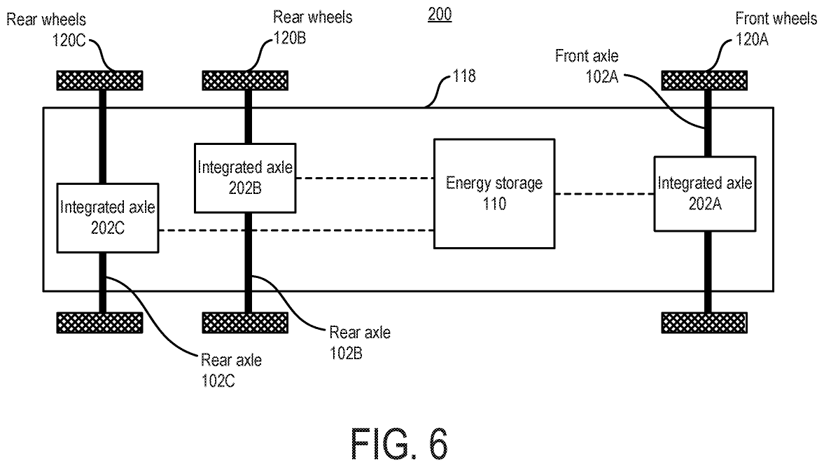

FIG. 5 shows an example of the system 200 with three axles 102A, 102B, and 102C, but instead of two integrated axles, only the front axle 102A is coupled with the integrated axle 202, and the two remaining rear axles 102B and 102C are coupled with differential gears 116A and 116B, respectively. The differential gears 116A and 116B are coupled with each other via the driveshaft 122 which may operate both of the gears simultaneously, using the power provided by the engine 104 and transferred through the transmission 114. As such, the rear axles 102B and 102C may be coupled with each other via the drift shaft 122.

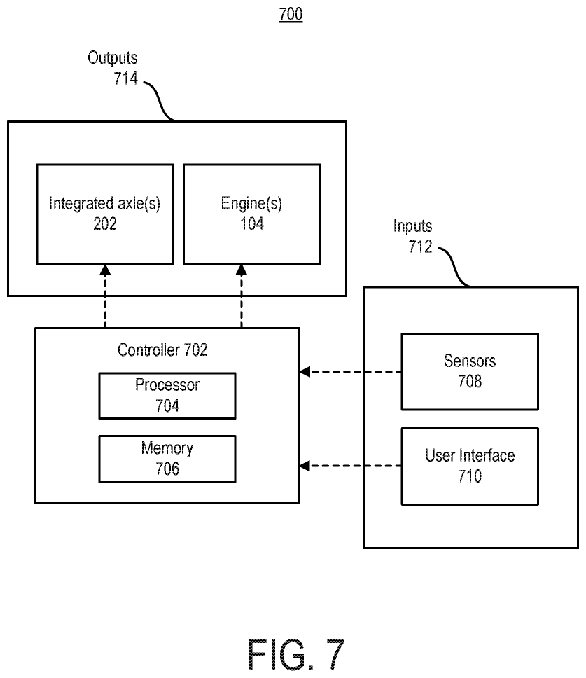

FIG. 6 shows an example of the system 200 with all three axles 102A, 102B, and 102C being powered electrically using the energy storage 110. That is, there are three integrated axles 202A, 202B, and 202C for the three axles, each independently operable, as controlled by a controller (not shown). In all examples disclosed herein, the front axle 102A is always implemented with an integrated axle, but the remaining axles may have integrated axles, engine-powered axles, or a combination of both.

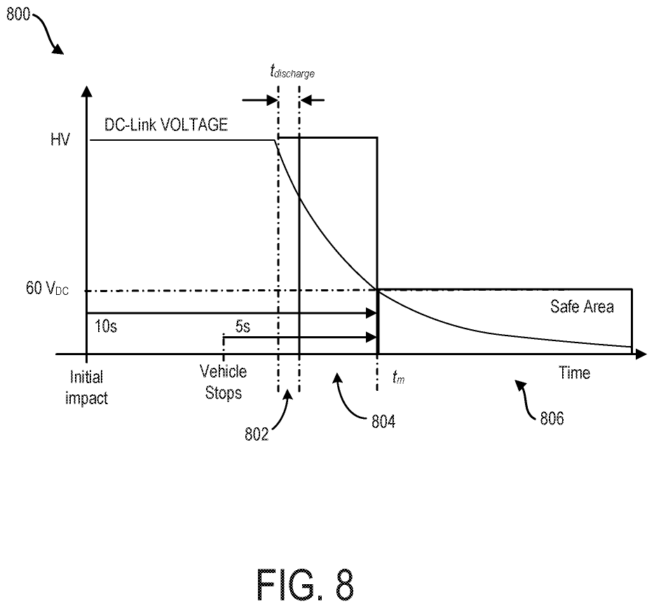

FIG. 7 shows an example of a control system 700 for the multi-mode hybrid vehicle system 200 as disclosed herein. The control system 700 includes a controller (multi-axle system controller) 702 which receives inputs 712 and controls the outputs 714. The controller 702 includes a processor 704 and a memory unit 706. The processor may be a microprocessor, a microcontroller, or any other suitable types of processing device or controller as known in the art. The controller 702 controls the operation of the integrated axle(s) 202 and engines 104 over communication lines, for example. It should be understood, however, that communication between controller and the integrated axle(s) and engine(s) may alternatively, or in addition, be performed wirelessly.

It should be understood that, in some embodiments, the controller 702 may form a portion of a processing subsystem including one or more computing devices having non-transient computer readable storage media, processors or processing circuits, and communication hardware. The controller 702 may be a single device or a distributed device, and the functions of the controller may be performed by hardware and/or by processing instructions stored on non-transient machine-readable storage media. Example processors include an application specific integrated circuit (ASIC), a field programmable gate array (FPGA), a digital signal processor (DSP), and a microprocessor including firmware. Example non-transient computer readable storage media includes random access memory (RAM), read only memory (ROM), flash memory, hard disk storage, electronically erasable and programmable ROM (EEPROM), electronically programmable ROM (EPROM), magnetic disk storage, and any other medium which can be used to carry or store processing instructions and data structures and which can be accessed by a general purpose or special purpose computer or other processing device.

Certain operations of the controller 702 described herein include operations to interpret and/or to determine one or more parameters. The parameters may be inputs 712 which may be information or data received from sensors 708 and/or user interface 710, among other means of providing inputs. The sensors may be any suitable sensor that can measure any change or increase in the load of the vehicle or the load applied on the vehicle. The sensors may include, but are not limited to, weight sensors which detect the physical weight of the vehicle and/or its cargo, gyroscopes which detect the incline or decline in which the vehicle may be traveling, and altimeters which detect the altitude or change in altitude as the vehicle travels, among others.

Interpreting or determining, as utilized herein, includes receiving sensor values by any method known in the art, including at least receiving values over communication lines, from a datalink, network communication or input device, receiving an electronic signal (e.g. a voltage, frequency, current, or pulse-width-modulation signal) indicative of the value, such as the current and expected loads of a vehicle as well as user's preference or whether the rear axles are approaching or reaching their performance limit, for example, as further explained herein, receiving a computer generated parameter indicative of the value, reading the value from a memory location on a non-transient machine readable storage medium, receiving the value as a run-time parameter by any means known in the art, and/or by receiving a value by which the interpreted parameter can be calculated, and/or by referencing a default value that is interpreted to be the parameter value.

The above-described embodiments of the technology described herein can be implemented in any of numerous ways. For example, the embodiments may be implemented using hardware, software or a combination thereof. When implemented in software, the software code (or software algorithm) can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of several forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone or any other suitable portable or fixed electronic device.

Also, a computing device may have one or more input and output devices. These devices can be used, among other things, to present the user interface 710 (which may be an output device as well as an input device). Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Such computing devices may be interconnected by one or more networks in any suitable form, including as a local area network, a controller area network, or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the disclosed embodiments may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the disclosure discussed herein. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of the disclosure, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

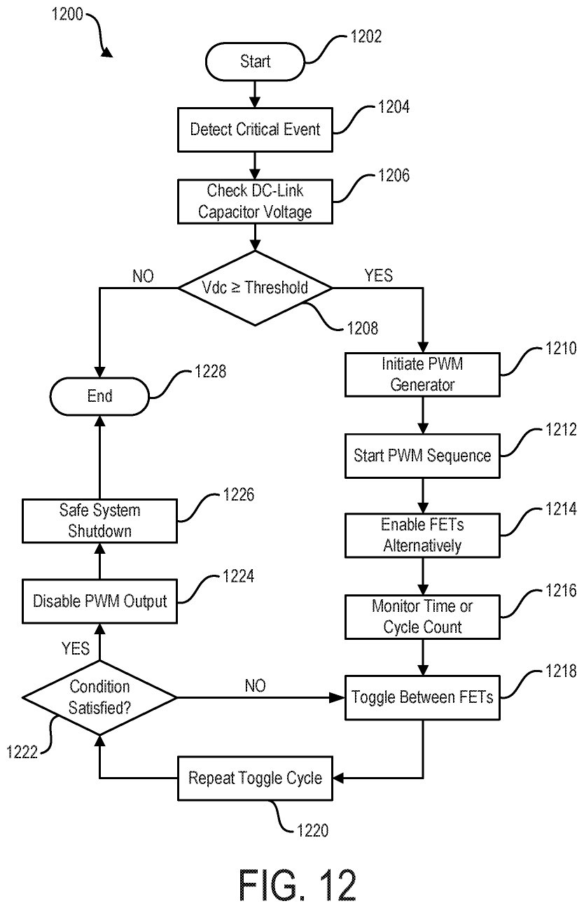

FIGS. 8 through 12 collectively illustrate the structural and functional aspects of a system for safely discharging a DC-Link Capacitor using pulse width modulation (PWM) in response to a critical event. FIGS. 8 through 11 present a sequence of diagrams that affirm the internal configuration and component relationships essential to the disclosed method and device. These diagrams demonstrate how the capacitor is operatively connected to the inverter and how the system engages one or both of the top and bottom end field-effect transistors (FETs) to direct energy into associated parasitic capacitances. The figures further confirm how toggling between the FETs can be used to modulate discharge while avoiding high current stress and thermal runaway, all without requiring real-time voltage or current monitoring. The modular and flexible design supports implementation across a range of gate drivers and allows the discharge time to be tuned as needed. FIG. 12 transitions from structural detail to operational logic by presenting a flowchart of the method, outlining the PWM sequence performed after a critical event and while the capacitor remains above a safe voltage threshold. Together, the figures substantiate the practical realization of the claims and establish a clear foundation for discussion of each component's role in achieving controlled, cost-effective capacitor discharge.

Each of these figures will be discussed in detail below, beginning with environmental considerations for implementation.

In BEVs, power electronics systems rely heavily on field-effect transistors (FETs) for efficient energy management and control. These FETs play a pivotal role in inverters, DC-DC converters, and battery management systems (BMS). They operate as high-speed switches, enabling precise regulation of voltage and current throughout the vehicle's electrical architecture. The use of FETs ensures efficient power transfer between the battery and various subsystems. By operating in tandem with advanced gate drivers, FETs achieve optimal switching performance, minimizing energy losses and thermal stress.

The power electronics architecture of a BEV typically involves the interplay of top and bottom FETs configured in a half-bridge arrangement. This configuration is essential for tasks such as converting direct current (DC) to alternating current (AC), voltage regulation, and safe energy discharge during emergency or routine conditions. The half-bridge design is central to creating the high-efficiency circuits needed for modern electric vehicles. Through careful synchronization, these FETs enable seamless operation of the motor and auxiliary systems. Additionally, their high switching speeds contribute to reducing size and weight in BEV power electronics.

Top FETs, often referred to as high-side switches, are connected between the positive DC bus and the load. They conduct current from the battery to the motor or other subsystems when activated. This requires specialized gate drivers to provide sufficient voltage above the source potential, ensuring reliable operation. These gate drivers must overcome challenges such as gate charge requirements and high voltage differentials. Additionally, the performance of top FETs directly influences the efficiency of energy delivery in high-voltage circuits.

Bottom FETs, or low-side switches, are connected between the load and the negative DC bus (ground). These switches provide a return path for current. Unlike top FETs, their gate drive requirements are simpler, as their source terminal is typically at ground potential. The reduced complexity in driving bottom FETs makes them a cost-effective component in BEV power systems. Furthermore, their robust design ensures reliable operation under varying load conditions, contributing to overall system stability.

One of the primary applications of top and bottom FETs is in the motor inverter, where they are organized into a three-phase configuration to convert DC battery power into AC signals. This enables precise motor control by synthesizing sinusoidal waveforms from pulse width modulation (PWM) techniques. The three-phase inverter setup allows for efficient energy distribution to the motor, enhancing vehicle performance. The use of FETs in this arrangement also reduces harmonics, improving overall system efficiency and reliability.

In the inverter's half-bridge circuits, PWM signals alternate the activation of top and bottom FETs. When the top FET is on, the bottom FET is off, and vice versa. This complementary switching ensures efficient energy transfer and avoids cross-conduction or shoot-through events. The precise timing of these switches is managed by advanced control algorithms, ensuring seamless operation. This method not only optimizes power delivery but also minimizes switching losses and heat generation.

Dead-time insertion between the switching of top and bottom FETs is crucial. It prevents simultaneous conduction, which could result in a short circuit across the DC bus. Advanced gate drivers, such as those discussed in the uploaded documents, include programmable dead-time control to optimize performance and prevent faults. By dynamically adjusting the dead-time, these systems enhance safety while maintaining high efficiency. Additionally, this feature helps prevent damage to the FETs, extending their operational lifespan.

Active discharge of the DC-link capacitor is another critical function facilitated by FETs. In BEVs, the DC-link capacitor stores energy that needs to be discharged safely during shutdown or emergencies. Utilizing half-bridge legs of the inverter, the FETs can discharge the capacitor through controlled pulses. This controlled discharge ensures compliance with safety standards, such as ISO 6469, which mandates rapid voltage reduction. The ability to perform this task reliably is vital for protecting both the system and its users.

The known gate drivers, for example, offer integrated solutions for active discharge, with features such as shoot-through protection disablement and precise DESAT (desaturation) monitoring for fault detection. This ensures both rapid and safe energy dissipation from the DC-link capacitor. By leveraging these advanced features, this disclosure enables robust performance in high-stress scenarios. Its compatibility with various FET technologies further enhances its versatility in BEV applications.

Pulse width modulation (PWM) is a core technique for controlling FETs in BEV applications. By varying the duty cycle of PWM signals, the effective voltage and current delivered to the load can be precisely regulated. This modulation also enables smooth motor operation and efficient power conversion. Advanced PWM strategies, such as space vector modulation, further optimize the utilization of the DC-link voltage. These techniques contribute to achieving higher torque and speed control in electric motors.

Advanced gate drivers, such as those from the EiceDRIVER™ series, offer additional features like programmable slew rate control. This allows for dynamic adjustments of the FET switching behavior, optimizing efficiency and reducing electromagnetic interference (EMI). The ability to fine-tune the slew rate minimizes noise generation, ensuring compliance with automotive EMC standards. These drivers also enhance the overall robustness of the BEV power system, making them suitable for a wide range of operating conditions.

The use of silicon carbide (SiC) MOSFETs in BEVs is becoming increasingly prevalent due to their superior switching speeds and thermal performance compared to traditional silicon FETs. SiC-based devices are particularly beneficial in high-voltage applications, enabling greater power density and efficiency. Their ability to operate at higher temperatures and voltages makes them ideal for next-generation electric vehicles. By integrating SiC MOSFETs, manufacturers can achieve significant reductions in system size and weight, enhancing vehicle range and performance.

In DC-DC converters, FETs are employed in step-up (boost) and step-down (buck) configurations. For step-up conversion, the bottom FET switches rapidly to transfer energy from the input inductor to the load at a higher voltage. For step-down conversion, the top FET regulates energy transfer to achieve a lower output voltage. These converters are essential for powering auxiliary systems in BEVs, such as infotainment and climate control. The use of FETs in these applications ensures high efficiency and reliability, even under varying load conditions.

Battery protection circuits also leverage FETs for safe operation. In fault conditions such as overcurrent, overvoltage, or thermal runaway, the FETs isolate the battery from the system, mitigating risks and preserving the longevity of the cells. Advanced gate drivers with integrated protection mechanisms enhance the reliability of these circuits. Features such as real-time fault monitoring and automated response capabilities ensure that the battery remains protected under all operating conditions.

The integration of programmable DESAT detection in gate drivers enables fast response to short-circuit conditions. For example, drivers disclosed herein off DESAT fault handling in less than 1 microsecond, minimizing stress on the FETs and the power stage. This rapid response capability is crucial for maintaining the integrity of the power electronics system. By detecting and mitigating faults promptly, these drivers enhance the safety and durability of BEVs.

Moreover, the ability to detect faults in real-time enables preventative measures to avoid cascading failures in the system. Gate drivers equipped with advanced diagnostic features can continuously monitor critical parameters, such as gate voltage, current, and temperature, providing valuable feedback to the control system. This continuous monitoring not only enhances safety but also allows for predictive maintenance, reducing downtime and operational costs. By leveraging these diagnostic capabilities, manufacturers can design BEVs that are more reliable and user-friendly.

Another advantage of advanced gate drivers is their ability to support various modulation schemes for precise control of FET operation. For instance, space vector modulation (SVM) can be employed to improve the utilization of the DC-link voltage and reduce harmonic distortion. This advanced control technique is particularly beneficial for achieving smoother motor operation and higher energy efficiency. By integrating such features, gate drivers contribute to the overall performance and sustainability of BEVs.

The role of active miller clamps in gate drivers is another critical consideration. These clamps prevent unintended turn-on of the FETs due to parasitic gate voltage coupling, ensuring reliable operation under high dv/dt conditions. This functionality is especially important in high-voltage applications where rapid voltage changes can induce spurious behavior in the FETs. By incorporating active miller clamps, gate drivers enhance the stability and robustness of BEV power electronics.

Minimizing electromagnetic interference (EMI) is a significant challenge in BEV power systems, and advanced gate drivers offer solutions through programmable slew rate control. By optimizing the switching speed of FETs, these drivers reduce noise generation and improve compliance with automotive EMC standards. This capability is essential for maintaining the performance and reliability of sensitive electronic components within the vehicle.

The implementation of redundant safety mechanisms in gate drivers further enhances their reliability in mission-critical applications. Features such as dual-channel DESAT detection and fault-tolerant gate control ensure robust operation even in the event of a component failure. This redundancy is crucial for meeting the high safety and reliability standards required in automotive systems, particularly those designed for autonomous driving.

For principles of the present disclosure, it is helpful 1 to identify example PWM pattern requirements. To begin, these principles can include switching on/off all the high-side devices at the same time. Optionally, these principles can include switching on/off all the low-side devices at the same time. Optionally, these principles can include a switching frequency is about 75 kHz. Optionally, duty cycle can be 10% and adjustable (E.g., increase or decreased this percentage if there is any challenge). Optionally, these principles can include a phase delay 190 degree of PWM_Low-side with reference to PWM_High-side signals. Optionally still, these principles cave include monitoring the DC-link voltage measurement and stopping the discharge process if it does not drop after 250 ms, being more precision about how much expected drop in the DC-link voltage within 250 ms.

Some methods are more dynamic than others. Table 1 below shows several active discharge solutions for dc-link capacitor through switching devices.

TABLE 1
Methodologies of gate drivers vs. supplier's observation and
corresponding opportunities, challenges, and/or limitations

| | | Supplier's | |
|---|---|---|---|
| | Methodology | Observation | Opportunities/Challenges/ Limitations |
| Gate | Based on toggling | Advantage of | Solution is restricted to availability |
| Driver | safety input pins of | using safety pins | of input safety pins per gate driver. |
| 1 | certain driver's | is their | Limited switching frequency of the |
| | family to | availability | safety pins as they are not intended |
| | charge/discharge | during MCU or | for switching operation. |
| | power module | KL30 failure. | Utilizing the safety pins for active |
| | parasitic capacitors | No risk of | discharge functions can be a concern |
| | | thermal runaway. | from safety perspectives. |
| Gate | Based on | Risk of thermal runaway. | Risk of thermal runaway |
| Driver | overlapping the | No intervention | Challenge of monitoring the FET |
| 2 | PWM signals of top | with input safety | current as sensing circuit speed up to |
| | and bottom FET in | pins | 2.7 ns. |
| | a single leg of the | | Overvoltage protection associated |
| | inverter to | | with the gate driver needs to be |
| | implement intended | | disabled. |
| | shoot-through | | Peak current stresses/degrades the |
| | | | FETs and impact their reliability |
| Gate | Based on operating | Better risk | Challenge of monitoring the FET |
| Driver | one FET of a single | management of | current as sensing circuit speed up to |
| 3 | leg of the inverter | thermal runaway. | 2.7 ns. |
| | continuously in on- | Current through | Overvoltage protection associated |
| | state and toggling | the FET is | with the gate driver needs to be |
| | the other FET in | controlled by | disabled. |
| | linear region | operating one | Intended shoot-through with a higher |
| | operation | FET in the linear | leg impedance helps limiting the |
| | | region | current passing through the leg. |
| Gate | Based on toggling | The PWM | No voltage/current monitoring |
| Driver | the top and bottom | signals need the | during the discharge process. |
| 4 | FETs through | be switching with | No risk of thermal runaway as there |
| | PWM signals | several tens of | is no shoot through. |
| | | kHz | Can be implemented in any gate |
| | | | driver through software/or hardware. |
| | | | No voltage/current stress on the |
| | | | devices. |

The table outlines three distinct methodologies for actively discharging the DC-link capacitor in power electronic systems, particularly in the context of inverter applications. Each method is associated with a specific gate driver control strategy and is evaluated based on supplier observations and associated technical opportunities, challenges, and limitations.

Gate Driver 1 utilizes a method based on toggling safety input pins of certain gate driver families to facilitate the charge or discharge of parasitic capacitors in the power module. This approach offers the advantage of being operable even in the event of a microcontroller (MCU) or KL30 power failure, as the safety pins can still function independently. It is also characterized by the absence of thermal runaway risk. However, this methodology is constrained by the number of available safety input pins per gate driver, which limits system scalability. Furthermore, safety pins are not designed for high-frequency switching, and their use for active discharge may raise safety concerns due to their original purpose being oriented toward fault signaling rather than power control.

Gate Driver 2 employs a technique that overlaps the PWM signals of both the high-side and low-side field-effect transistors (FETs) in a single inverter leg to intentionally create a shoot-through condition. This direct conduction path allows for rapid energy dissipation from the DC-link capacitor. The approach bypasses the use of safety input pins, simplifying signal routing. However, it introduces a significant risk of thermal runaway due to continuous high current flow. Monitoring the current through the FETs is challenging given the need for sensing circuit response times below 2.7 nanoseconds. To execute this method, overvoltage protection mechanisms in the gate driver must be disabled, which exposes the system to voltage transients. Additionally, repeated exposure to high peak currents can degrade FET reliability and reduce overall system lifespan.

Gate Driver 3 adopts a control strategy where one FET in the inverter leg remains in an on-state continuously, while the other FET is operated in the linear region to regulate current flow. This method is viewed as having improved thermal runaway management, as current is more controllable and spread over a longer time interval. The regulation of current through the linear operation of one FET allows for finer control over the discharge rate. However, similar to Gate Driver 2, this approach also faces challenges in accurately sensing FET current at high speeds. The necessary disabling of overvoltage protection introduces reliability concerns. That said, shoot-through events are inherently limited by the higher impedance present in the leg during linear operation, which helps restrict the peak current through the devices.

Gate Driver 4 is based on toggling the top and bottom FETs through PWM signals. The PWM signals need the be switching with several tens of kHz. However, there is no voltage/current monitoring during the discharge process, no risk of thermal runaway as there is no shoot through, and no voltage/current stress on the devices. Optionally, it can be implemented in any gate driver through software/or hardware.

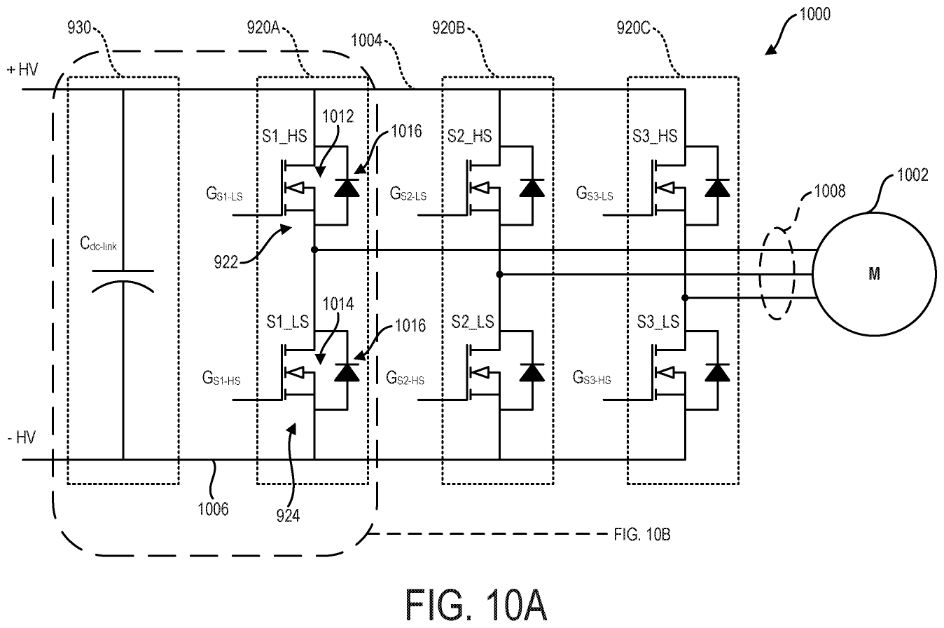

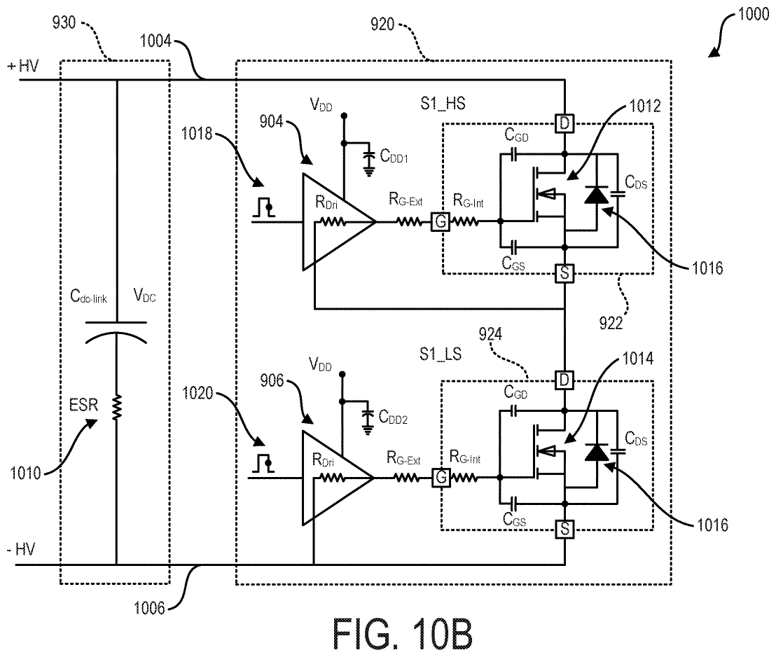

The illustrated diagrams of FIGS. 9A and 9B present an overview of three general methodologies used to achieve active discharge of the DC-link capacitor in a power electronics system, particularly through the switching devices of a three-phase inverter. The diagrams include both control and power stage representations, emphasizing how microcontroller (MCU)-based logic interfaces with high-side (HS) and low-side (LS) gate drivers to implement discharge strategies.

FIG. 9A features a control and gate-driving circuit 900. An AURIX microcontroller unit (MCU) 902 is used to control both the HS gate driver 904 and the LS gate driver 906. Each driver includes a Pulse Width Modulation (PWM) input 908 and two safety inputs (SI1 910 and SI2 912). These safety inputs are wired to a safety logic unit 914 and the MCU 902, enabling toggling of gate driver states for fault handling or for active discharge functions. The gate drivers 904 and 906 receive high-voltage (+HV) supply inputs 916 and interface directly with power transistors (e.g., MOSFETs or IGBTs) located in the inverter leg.

Three approaches to discharge the DC-link capacitor are denoted. In a repetitive shoot-through for a short period, this method involves deliberately activating both the HS and LS switching devices in the same inverter leg simultaneously or near-simultaneously to create a low-impedance path. The resulting shoot-through condition discharges the capacitor (C_dc-link) through the conduction path formed by the switching devices and their internal resistance (R_DS(on)). This technique must be time-limited and precisely controlled to prevent thermal overstress and device degradation.

In a safety pin toggling for certain gate drivers, this method utilizes the safety input pins (SI1, SI2) of specific gate drivers to initiate the discharge. By toggling these safety pins, the gate drivers are forced into a state where the switching devices enter conduction, allowing the capacitor to discharge. This method depends on the availability and behavior of safety pin functionality in the driver ICs and is generally independent of MCU operation, offering a potential path for discharge during fault conditions such as MCU or control failure.+

In a PWM switching method, an example approach suggests using standard PWM control of the HS and LS switches to manage the discharge process. By generating PWM signals with specific duty cycles and dead-time configurations, the gate drivers modulate the discharge rate. The PWM-controlled switching enables smoother energy dissipation across the internal resistances of the devices and associated snubber or discharge paths. This strategy allows for more precise control of discharge timing, potentially reducing stress on components while maintaining adherence to safety discharge standards (e.g., ISO 6469's 60V threshold within 5 seconds).

In FIG. 9B, the power stage schematic illustrates a single leg 920 of a three-phase inverter. It includes an HS switching device 922 and an LS switching device 924, each with an associated drain-source resistance 926 (R_DS(on)) and parasitic drain capacitance 928 (c). The DC-link capacitor 930 (C_dc-link) is shown connected to the common node of the half-bridge. Discharge occurs through these components, depending on the selected control method from the three described above.

Together, the control and power circuitry in FIGS. 9A and 9B depict how MCU-coordinated logic, safety features, and PWM modulation can be utilized in various configurations to safely and efficiently discharge stored energy in a DC-link capacitor. These methodologies are designed with trade-offs between complexity, reliability, responsiveness, and thermal management considerations.

Several advantages can be realized by applying the principles of the present disclosure. Notably, the approach requires no intervention with safety compliance protocols and eliminates the need for monitoring current or voltage during the discharge process. It effectively mitigates the risk of thermal runaway and prevents high current stress on the field-effect transistors (FETs). The method is broadly compatible, as it can be implemented with most, if not all, gate drivers. It also offers high flexibility in managing discharge time and is simple to implement, whether through software using regular PWM with fixed frequency and duty cycle, or through a hardware circuit that generates PWM signals. Importantly, these benefits are achieved without adding cost.

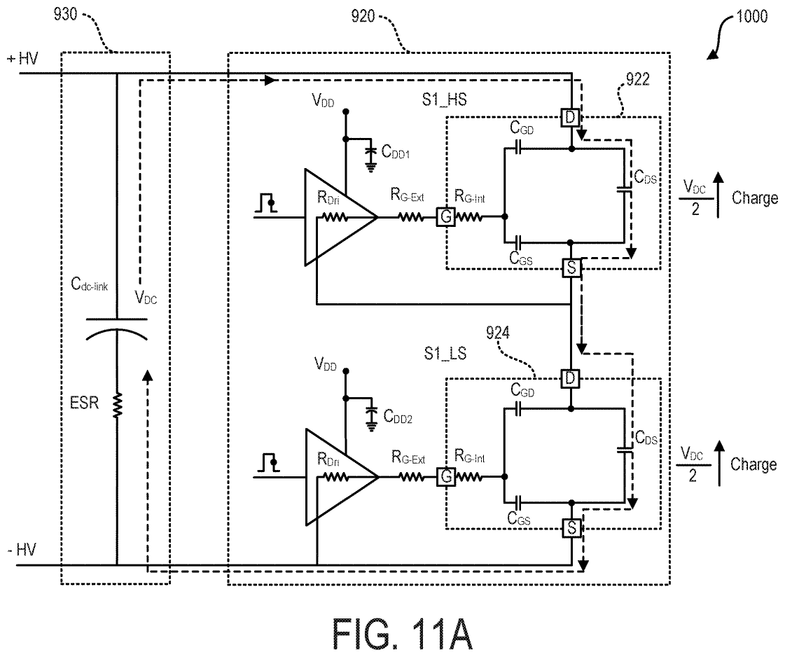

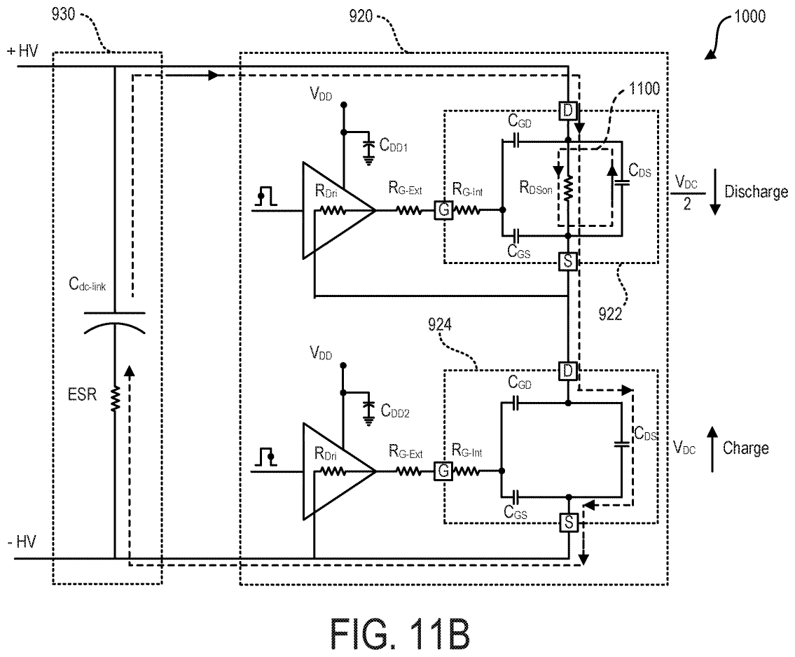

Turning to a technical description of 3-phase traction inverter, FIG. 10A represents a 3-phase traction inverter 1000, a core component in the electric drive system of battery electric vehicles (BEVs) and hybrid electric vehicles (HEVs). This inverter 1000 converts high-voltage direct current (DC) from the vehicle's battery pack into three-phase alternating current (AC) to power an electric traction motor 1002, labeled as “M” in the figure.

The inverter 1000 is composed of three legs (920A, 920B, and 920C), each corresponding to one of the three AC output phases—U, V, and W. Each leg 920 includes two power semiconductor switches (a.k.a. switching devices) arranged in a half-bridge configuration: an upper (high-side) switch 922 and a lower (low-side) switch 924. These switches are typically implemented using IGBTs or SiC MOSFETs due to their high efficiency and capability to handle the elevated power levels and switching frequencies required in traction applications.

The high-side switches 922 are connected to the positive DC bus 1004 (VDC+), and the low-side switches are connected to the negative DC bus 1006 (VDC−). The midpoints of each leg (between the upper and lower switches) serve as the AC phase outputs 1008 to the traction motor. By alternately switching the devices using precisely timed PWM (pulse-width modulation) signals, the inverter 1000 generates sinusoidal voltage waveforms with appropriate phase shifts, enabling controlled torque and speed output from the motor.

Gate drivers (e.g., HS gate driver 904 and LS gate driver 906) are used to control each power switch, providing the necessary voltage and current to achieve fast and efficient switching. These gate drivers also incorporate critical protection features such as under-voltage lockout (UVLO), short-circuit detection, and active Miller clamps to ensure safe and reliable operation under dynamic driving conditions.

In traction applications, additional design considerations include regenerative braking, where energy is recovered during deceleration and fed back into the battery. The bidirectional nature of the inverter circuit accommodates this functionality. Furthermore, current sensing mechanisms, often implemented using shunt resistors or Hall sensors, enable closed-loop motor control strategies such as vector control or field-oriented control (FOC).

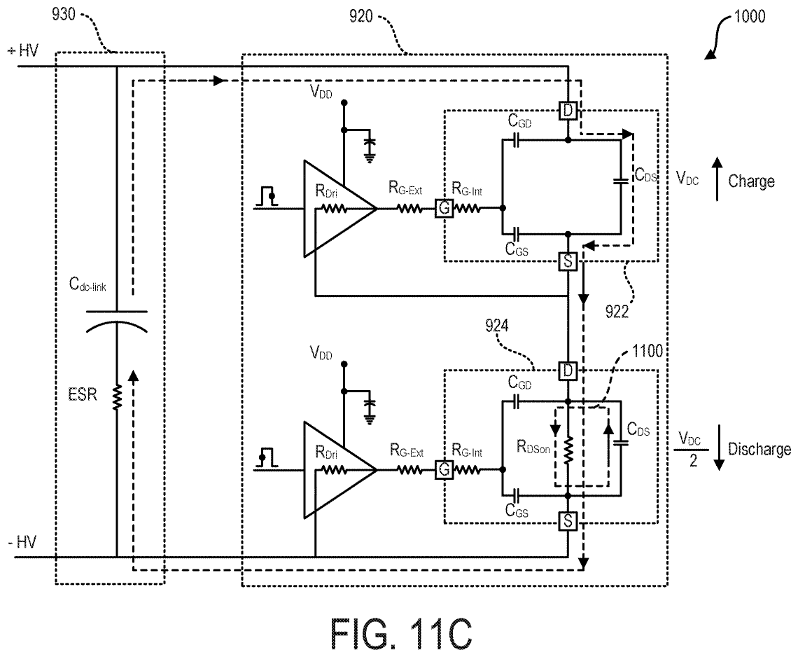

This 3-phase traction inverter topology is widely adopted due to its robustness, scalability, and efficiency. It enables precise motor control necessary for vehicle propulsion while supporting energy-saving features critical for extending driving range and improving overall vehicle performance. Components used for parasitic capacitance content include single leg with dc-link capacitor from traction inverter with parasitic capacitance. FIGS. 11A through 11C illustrate the multicycle process to discharge the DC-Link capacitor 930 using the leg 920 of the three-phase inverter 1000 according to the current flow in the direction shown by the dotted arrow. FIG. 11A shows the first discharge cycle during which parasitic capacitances (C_{DS}) of the HS switching device 922 and the LS switching device 924 each causes charging of V_{DS}/2. FIG. 11B shows the second discharge cycle during which the parasitic capacitance (C_{DS}) of the HS switching device 922 each causes discharging of V_{DS}/2 due to current flow 1100 through the parasitic capacitance (C_{DS}) and the internal resistance (R_{DSon}), and the parasitic capacitance (C_{DS}) of the LS switching device 924 causes charging of V_{DS}. FIG. 11C shows the third discharge cycle during which the parasitic capacitance (C_{DS}) of the HS switching device 922 causes charging of V_{DS} and the parasitic capacitance (C_{DS}) of the LS switching device 924 causes discharging of V_{DS}/2 due to current flow 1100 through the parasitic capacitance (C_{DS}) and the internal resistance (R_{DSon}). After each cycle, the VDC reduces by some millivolts due to charging the switching devices output parasitic capacitance (C_{DS}). The entire dc-link capacitor discharge pattern is an exploitational curve.

The system described herein pertains to a method for discharging a DC-Link capacitor that is electrically connected to a traction inverter in a battery-based power circuit. The capacitor is discharged through the use of a controlled pulse width modulation (PWM) sequence following a critical event, such as a fault or shutdown condition. This PWM sequence is structured to reduce the voltage on the DC-Link capacitor in a controlled and predictable manner by routing the residual energy into parasitic components already present in the switching network. These parasitic elements, particularly the output capacitances of the field-effect transistors (FETs), are used as temporary energy sinks, avoiding the need for external discharge resistors or additional sensor feedback mechanisms.

The discharge process is initiated upon detection of a triggering condition, such as an emergency shutdown or system failure. At that point, a microcontroller unit (MCU) or equivalent digital controller begins executing a PWM routine configured with pre-set frequency and duty cycle values. These values are selected to balance safe discharge rates with thermal and electrical reliability of the components, typically falling within a practical range for standard traction inverter applications. Each of the three inverter legs includes a high-side and a low-side FET, which are alternately driven by the PWM signals. The switching pattern is designed to transfer charge from the DC-Link capacitor into the parasitic capacitances (C_{DS}) of the switching devices.

The method exploits the natural electrical behavior of each inverter leg. When a high-side FET is activated, a portion of the DC-Link energy is transferred into its output parasitic capacitance, reducing the overall voltage. The process is repeated with the low-side FET, and then both FETs are toggled in a controlled sequence. The switching pattern is maintained for a set duration or number of cycles rather than relying on real-time voltage or current measurements. This ensures the system functions effectively even in degraded sensor conditions or when the primary monitoring system is offline.

The hardware configuration supporting this method includes a central processor, memory containing program instructions, and a PWM generation module. The PWM signal may be generated entirely by software, by dedicated hardware logic, or by a combination of both, depending on the desired redundancy level. In a hybrid design, the software controller initiates the sequence and hands off to a hardware-based oscillator or logic circuit if needed. This provides a fail-operational mode in scenarios where software execution may be interrupted.

Each switching event is brief, controlled by the PWM parameters, and followed by a short off period to avoid shoot-through conditions. Over time, repeated toggling between the high-side and low-side FETs leads to a gradual decay of the DC-Link voltage. This decay resembles an exponential discharge curve, with the rate determined by the parasitic capacitance values and the switching frequency. The discharge time is selected such that it completes within a window of approximately five seconds or less, minimizing risk of thermal buildup or stress to components.

This approach utilizes existing inverter topology and inherent parasitic characteristics to provide a self-contained method of discharging stored energy in a safe and predictable manner. It avoids the complexity and cost of additional hardware discharge paths while offering flexibility in both implementation and operation. The sequence continues until a timer elapses or a safe voltage threshold is reached based on pre-defined criteria, after which all gate signals are disabled and the system enters a safe shutdown state.

FIGS. 10A and 10B illustrate the hardware configuration of a three-phase traction inverter 1000 and a detailed representation of one inverter leg 920, highlighting the parasitic capacitance and gate driver elements. The inverter 1000 is designed for applications such as electric vehicle traction systems, where high-efficiency power conversion and safe energy management are required. At the core of the system is a DC-Link capacitor 930, connected across high-voltage rails labeled +HV (positive DC bus 1004) and −HV (negative DC bus 1006). This capacitor 930 provides energy storage and stabilization for the DC bus and plays a crucial role during both normal inverter operation and controlled discharge events. The capacitor is modeled with an equivalent series resistance 1010 (ESR) to account for internal power dissipation losses.

The three-phase inverter structure is composed of three power modules (or legs 920A, 920B, and 920C), each corresponding to one of the three phases and identified as S1, S2, and S3. Each phase-leg includes a high-side field-effect transistor 1012 (FET) and a low-side FET 1014. These FETs are equipped with anti-parallel diodes 1016, enabling bidirectional current flow and freewheeling behavior during switching. Each FET receives an individual gate signal (e.g., HS FET 1012 receives HS gate signal 1018, LS FET 1014 receives LS gate signal 1020) from a dedicated gate driver circuit (e.g., gate drivers 904 and 906). The midpoints of each inverter leg 920 connect to a three-phase motor 1002, forming the output interface 1008 of the inverter 1000. The inverter structure allows independent control of each leg while maintaining synchronized operation for balanced three-phase output.

Focusing on a single leg 920, FIG. 10B shows the internal circuitry and gate driver components that control the high-side switch 922 and low-side switch 924. Each switch 922 or 924 is managed by an isolated gate driver 904 or 906 that receives a logic-level PWM signal 1018 or 1020, which is amplified to a gate drive voltage level. The gate drivers are powered by independent low-voltage supplies (VDD) and stabilized by local decoupling capacitors (C_{DD1} and C_{DD2}). Between the gate driver 906 or 906 and each transistor gate (of FET 1012 or 1014), respectively, are gate resistors—R_{Dri}, R_{G-Ext}, and R_{G-Int}—which help tailor the switching speed and manage electromagnetic interference by controlling the gate charge and discharge currents.

Each FET (e.g., of FETs 1012 and 1014) in the inverter leg 920 also contains parasitic capacitances intrinsic to its semiconductor structure. These include the output capacitance (C_{DS}), which exists between the drain and source terminals and plays a pivotal role during controlled capacitor discharge events. Additional parasitics include the gate-to-drain capacitance (C_{GD}) and gate-to-source capacitance (C_{GS}). C_{GD} influences the switching dynamics through its contribution to the Miller effect during transitions, while Cos affects gate drive current and timing behavior. These parasitic elements are passive byproducts of the transistor's internal layout but are leveraged in the described discharge method.

During normal inverter operation, the gate drivers 904, 906 alternate the high-side FETs 1012 and low-side FETs 1014 to synthesize a three-phase AC waveform from the DC input. However, during a fault or shutdown condition, the same FETs 1012, 1014 and their parasitic capacitances (e.g., C_{GD} and C_{GS}) are used for a controlled discharge of the DC-Link capacitor 930. A sequence of PWM signals is applied to toggle the FETs 1012, 1014 in a timed manner, allowing energy from the capacitor 930 to redistribute into the output capacitances (C_{DS}) of the transistors 1012,1014. This approach eliminates the need for dedicated discharge resistors and voltage sensors, providing a built-in discharge mechanism that utilizes existing hardware components. The system achieves passive and gradual discharge of the DC-Link capacitor 930, enhancing safety and simplifying circuit complexity while maintaining compatibility with standard power module architectures.

The disclosed method relates to a process and associated hardware for discharging a DC-Link capacitor in a traction inverter circuit via a pulse width modulation (PWM) sequence. The method is particularly suited to battery circuits involving silicon carbide (SiC) power switching devices, which exhibit parasitic capacitance characteristics. Following a critical event such as a fault or emergency stop, the system initiates a controlled discharge of the DC-Link capacitor to reduce the potential for residual energy hazards. This is achieved by modulating gate signals to the switching devices, systematically allowing charge redistribution between the DC-Link capacitor and the parasitic output capacitances (C_{DS}) of field-effect transistors (FETs) in the inverter circuit.

The process begins by configuring the PWM sequence across three inverter legs, each with a high-side and a low-side FET. The initial setup ensures all top devices and all bottom devices in the inverter legs are enabled simultaneously. This PWM control is managed by either software instructions on a microcontroller unit (MCU) or through a hardware PWM circuit. The software-based implementation permits configuration of switching frequency and duty cycle, with values typically ranging between 50 to 80 kHz and 10% to 20%, respectively. These values are chosen to balance effective discharge time against thermal and electrical stress on the components.

Once the PWM sequence is initiated, the top and bottom switches begin alternating, enabling a step-wise discharge of the DC-Link capacitor. In the first cycle, one switch (for example, the high-side FET) allows its associated output parasitic capacitance to charge from the DC-Link, slightly reducing the overall voltage. This is followed by a similar operation on the complementary FET (low-side), with parasitic capacitances acting as temporary energy sinks. The switching pattern can be repetitive and toggled to exploit the energy absorption capabilities of each leg's parasitic components without requiring external load resistors or bleed circuits.

Throughout successive cycles, the voltage across the DC-Link capacitor decreases gradually, following an exponential-like decay. This behavior arises due to the cumulative effect of parasitic capacitance charging in each switching cycle. Importantly, the system does not rely on real-time sensing of voltage or current; rather, it is governed by a predetermined number of switching cycles or a time duration (typically less than five seconds). This removes complexity from the discharge strategy and enhances fault tolerance, as it is not dependent on sensor feedback that could be compromised during critical conditions.

To support fail-safe operation, the PWM generation system can be implemented either as a hardware-based oscillator (e.g., 555 timer circuit) or as a hybrid solution involving both MCU and logic-controlled hardware. This flexibility allows for redundancy—wherein the discharge process may still proceed via hardware logic even if the MCU becomes inoperative. This dual-mode capability supports safety compliance and extends usability across different inverter architectures, including three-phase traction systems common in electric vehicles.

The complete system comprises a storage medium with program instructions and a processor configured to execute the above-described PWM sequences. The processor initiates the discharge routine upon detection of a trigger event, ensuring controlled dissipation of the energy stored in the DC-Link capacitor. By relying on the parasitic elements inherent in the switching modules, the design avoids the need for additional discharge resistors and complex sensing mechanisms. This method and associated system support modular design, simplified circuitry, and enhanced safety outcomes in high-voltage traction inverter environments.

The flowchart of FIG. 12 outlines a comprehensive, step-by-step process 1200 for safely discharging a DC-Link capacitor in a traction inverter system using a pulse width modulation (PWM)-based control strategy. This method is initiated following a critical event—such as an emergency shutdown, electrical fault, or power-off sequence—where residual energy stored in the DC-Link capacitor must be dissipated to prevent safety hazards, component damage, or unintended operation.

Each node in the process 1200 may be considered as a step in performing the process. In some examples, one or more nodes may be combined together in a single operation, if suitable. In some examples, one node may incorporate a plurality of steps or operations, if suitable. The process 1200 begins at the “Start” node 1202, where the system is in a monitoring or standby state. The first operation, at the “Detect Critical Event node 1204,” represents a system-level interrupt or fault trigger that indicates an unsafe or transitional operating condition. Upon detecting this condition, the system transitions to the next step: the “Check DC-Link Capacitor Voltage” node 1206. A decision point 1208 then evaluates where the value of the DC-Link Capacitor Voltage (Vdc) is at or above a threshold voltage. This decision point evaluates whether the capacitor's voltage is still above a predefined safety threshold (e.g., ISO 6469's 60V threshold). If the voltage is already below this threshold, the system follows an exit path toward the “End” node 1228, thereby safely terminating the discharge sequence without initiating further control actions.

If the voltage is still elevated (YES), the system advances to the “Initialize PWM Generator” node 1210. In this step, a PWM control unit—typically software running on a microcontroller (MCU) or a hardware timer circuit—is configured with preset parameters. These parameters include a switching frequency, generally between 50 kHz and 80 kHz, and a duty cycle between 10% and 20%. These values are chosen based on the DC-Link capacitor size, inverter parasitic capacitance values, and the desired discharge time, ensuring the process occurs gradually and within safe thermal and electrical limits.

Once the PWM generator is configured, the next operation is the “Start PWM Sequence” node 1212 where the actual toggling of the power switches begins. This involves sequentially enabling the top-side and bottom-side field-effect transistors (FETs) across the inverter legs. The “Enable FETs Alternately” node 1214 ensures that both types of switches (i.e., top and bottom, or HS and LS, switches) participate in the discharge process: the top FETs enable energy to flow into their output capacitance (C_{DS}) from the DC-Link, while the bottom FETs enable similar behavior on the opposite rail. This alternating action avoids direct shoot-through (a condition where both switches in a leg conduct simultaneously) and utilizes parasitic components already present in the system.

As the switching sequence continues, the system enters the “Monitor Time or Cycle Count” node 1216. Here, the control logic keeps track of elapsed time or the number of completed PWM cycles. This monitoring ensures that the discharge operation concludes within a fixed timeframe—typically not exceeding five seconds—to minimize risk and avoid overstressing the inverter components.

Following this, the system loops through the “Toggle Between FETs” node 1218, which is a continuous cycle where top and bottom FETs are alternately activated according to the defined PWM timing. This toggling is where the actual discharge occurs: each time a FET turns on, its parasitic C_{DS} charges slightly, drawing energy from the DC-Link capacitor and lowering the overall voltage. The system allows a short off period (dead time) between toggles to avoid simultaneous conduction, further enhancing safety.

The process then advances to the “Repeat Toggle Cycle” node 1220, which reflects the iterative nature of the discharge. During this stage, the DC-Link capacitor's voltage decreases incrementally—typically in millivolt steps—with each completed toggle cycle. The discharge curve over time resembles an exponential decay, with the rate influenced by switching frequency, duty cycle, and parasitic capacitance magnitude.

At each iteration, the logic checks whether the timeout condition or estimated DC-Link voltage threshold has been reached, or whether the estimated DC-Link voltage is below the aforementioned threshold as outlined in the decision point “Condition Satisfied?” 1222. If this condition is satisfied, the process transitions to the “Disable PWM Output” node 1224. This step halts all PWM signals and places the inverter in a quiescent state, isolating the capacitor and preventing further current flow. Gate drivers are disabled, ensuring that the power switches remain off.

The final steps include the “Safe System Shutdown” node 1226, which represents post-discharge operations such as system isolation, safe-state confirmation, or MCU logging. This concludes at the “End” node 1228, signifying a completed and secure discharge process.

In summary, this flowchart of FIG. 12 defines a robust and structured approach to managing residual energy in high-voltage inverter systems. It uses system-level detection, programmable PWM control, intrinsic hardware parasitics, and safe-state verification to discharge a DC-Link capacitor without requiring external discharge hardware or real-time sensing, thereby enhancing reliability and simplifying design.

This flowchart of FIG. 12 outlines a control sequence designed to safely discharge a high-voltage DC-link capacitor following the detection of a critical event within a power electronic system. The process commences at the “Start” node 1202 and advances to step 1, wherein the system continuously monitors for abnormal or fault conditions that necessitate a protective response. Upon detecting such a condition, the process proceeds to step 2, where the voltage across the DC-link capacitor is measured. If the measured voltage is below a defined safety threshold—indicating no risk of hazardous energy levels—the control exits the routine with no further action. This is represented by the “End” node 1228.

Conversely, if the DC-link voltage exceeds the safe threshold, the flow advances to step 3, where the system initializes a pulse-width modulation (PWM) generator. This involves configuring the PWM frequency within a range of 50-80 kHz and setting a conservative initial duty cycle between 10-20%, selected to ensure controlled and gradual energy discharge. In step 4, the PWM sequence is activated, providing gate control signals to the switching devices.

Step 5 involves alternately enabling the high-side and low-side field-effect transistors (FETs) within the half-bridge circuit topology. This alternating operation allows the intrinsic output capacitance (C_{DS}) of each FET to participate in the controlled discharge of the DC-link, converting stored charge into heat within the devices. Step 6 introduces monitoring logic to track either the elapsed time or the number of switching cycles, ensuring that the discharge operation does not exceed a predefined maximum duration, typically constrained to ≤5 seconds to avoid thermal overstress.

In step 7, the controller toggles the gate signals between the top and bottom FETs while enforcing a dead-time interval to prevent simultaneous conduction, thereby mitigating the risk of shoot-through faults. The toggling behavior continues in step 8, gradually reducing the DC-link voltage through repetitive, controlled discharge cycles. This process leverages the parasitic characteristics of the power stage to achieve an exponential decay in capacitor voltage, with each cycle contributing a small voltage decrement.

Upon reaching step 9, the system evaluates whether either a timeout has occurred or the estimated DC-link voltage has dropped below the predefined threshold. If either condition is met, the control logic proceeds to step 10, in which the PWM output is disabled, and all gate driver signals are deactivated to electrically isolate the capacitor bank from the switching stage. This ensures that no unintended switching occurs post-discharge. In step 11, the system executes a safe shutdown protocol, bringing the entire power subsystem to a non-energized state under controlled conditions. The sequence terminates at the “End” node 1228, having ensured the safe dissipation of residual energy and the protection of system components.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, when an element, component, device or layer is described as being “on” “connected to,” “coupled to” or “in contact with” another element, component, device or layer, it can be directly on, directly connected to, directly coupled with, in direct contact with, or intervening elements, components, devices or layers may be on, connected, coupled or in contact with the particular element, component or layer, for example. When an element, component, device or layer for example is referred to as being “directly on,” “directly connected to,” “directly coupled to,” or “directly in contact with” another element, component, device or layer, there are no intervening elements, components, devices or layers for example.

Although illustrative methods may be represented by one or more drawings (e.g., flow diagrams, communication flows, etc.), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” “series” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

What is claimed is:

1. A method for safely discharging a direct-current link capacitor that is operatively connected to an inverter in a battery circuit via pulse width modulation, the method comprising:
performing a pulse width modulation sequence after experiencing a critical event and while the direct-current link capacitor is above a safe voltage to inhibit residual energy mishaps resulting from the critical event, the pulse width modulation sequence including a number of switches corresponding to a discharge time of the direct-current link capacitor to the safe voltage.

2. The method of claim 1, wherein the pulse width modulation sequence engages at least one of a top end field-effect transistor and a bottom end field-effect transistor, each of which is operatively connected to the inverter such that the direct-current link capacitor is discharged to a top end parasitic capacitance when the pulse width modulation sequence engages the top end field-effect transistor and the direct-current link capacitor is discharged to a bottom end parasitic capacitance when the pulse width modulation sequence engages the bottom end field-effect transistor.

3. The method of claim 2, wherein the pulse width modulation sequence engages both the top end field-effect transistor and the bottom end field-effect transistor.

4. The method of claim 3, wherein the pulse width modulation sequence toggles between the top end field-effect transistor and the bottom end field-effect transistor.

5. The method of claim 1, wherein the discharge time is less than or equal to 5 seconds.

6. The method of claim 1, wherein the pulse width modulation sequence operates independently from monitoring at least one of a monitored voltage that is indicative of a voltage at the direct-current link capacitor and a monitored current that is indicative of a current at the direct-current link capacitor.

7. The method of claim 1, wherein the pulse width modulation sequence operates independently from monitoring both a monitored voltage that is indicative of a voltage at the direct-current link capacitor and a monitored current that is indicative of a current at the direct-current link capacitor.

8. The method of claim 1, wherein the discharge time is set so as to minimize risk of thermal runaway by inhibiting shoot through and to minimize stress on components in the battery circuit.

9. A device for safely discharging a direct-current link capacitor that is operatively connected to an inverter in a battery circuit comprising:
a storage device; and
a processor executing program instructions stored in the storage device and being configured to perform a pulse width modulation sequence after experiencing a critical event and while the direct-current link capacitor is above a safe voltage to inhibit residual energy mishaps resulting from the critical event, the pulse width modulation sequence including a number of switches corresponding to a discharge time of the direct-current link capacitor to the safe voltage.

10. The device of claim 9, wherein the pulse width modulation sequence engages at least one of a top end field-effect transistor and a bottom end field-effect transistor, each of which is operatively connected to the inverter such that the direct-current link capacitor is discharged to a top end parasitic capacitance when the pulse width modulation sequence engages the top end field-effect transistor and the direct-current link capacitor is discharged to a bottom end parasitic capacitance when the pulse width modulation sequence engages the bottom end field-effect transistor.

11. The device of claim 10, wherein the pulse width modulation sequence engages both the top end field-effect transistor and the bottom end field-effect transistor.

12. The device of claim 11, wherein the pulse width modulation sequence toggles between the top end field-effect transistor and the bottom end field-effect transistor.

13. The device of claim 9, wherein the discharge time is less than or equal to 5 seconds.

14. The device of claim 9, wherein the pulse width modulation sequence operates independently from monitoring at least one of a monitored voltage that is indicative of a voltage at the direct-current link capacitor and a monitored current that is indicative of a current at the direct-current link capacitor.

15. The device of claim 9, wherein the pulse width modulation sequence operates independently from monitoring both a monitored voltage that is indicative of a voltage at the direct-current link capacitor and a monitored current that is indicative of a current at the direct-current link capacitor.

16. The device of claim 9, wherein the discharge time is set so as to minimize risk of thermal runaway by inhibiting shoot through and to minimize stress on components in the battery circuit.

17. A system for facilitating safe capacitor discharging, the system comprising:
a battery circuit comprising: an inverter, a direct-current link capacitor that is operatively connected to the inverter, and one or more processors configured to:
perform a pulse width modulation sequence after experiencing a critical event and while the direct-current link capacitor is above a safe voltage to inhibit residual energy mishaps resulting from the critical event, the pulse width modulation sequence including a number of switches corresponding to a discharge time of the direct-current link capacitor to the safe voltage.

18. The system of claim 17, wherein the pulse width modulation sequence engages at least one of a top end field-effect transistor and a bottom end field-effect transistor, each of which is operatively connected to the inverter such that the direct-current link capacitor is discharged to a top end parasitic capacitance when the pulse width modulation sequence engages the top end field-effect transistor and the direct-current link capacitor is discharged to a bottom end parasitic capacitance when the pulse width modulation sequence engages the bottom end field-effect transistor.

19. The system of claim 18, wherein the pulse width modulation sequence engages both the top end field-effect transistor and the bottom end field-effect transistor.

20. The system of claim 19, wherein the pulse width modulation sequence toggles between the top end field-effect transistor and the bottom end field-effect transistor.
